(19) United States
(12) Patent Application Publication
(10) Pub. No.: US 2022/0328942 A1
(43) Pub. Date: Oct. 13, 2022

(54) Methods and Apparatus for a Battery Cell with a Grating

(71) Applicant: Atlis Motor Vehicles, Inc., Mesa, AZ (US)

(72) Inventors: Moriah Counts, Baltimore, MD (US); Archit Deshpande, Tempe, AZ (US); Craig Trzebny, Phoenix, AZ (US); Demarco Cason, Tempe, AZ (US); Mark Hanchett, Mesa, AZ (US)

(73) Assignee: Atlis Motor Vehicles, Inc., Mesa, AZ (US)

(21) Appl. No.: 17/852,460

(22) Filed: Jun. 29, 2022

Related U.S. Application Data
(60) Provisional application No. 63/217,124, filed on Jun. 30, 2021.
(60) Provisional application No. 63/228,482, filed on Aug. 2, 2021.

(51) Int. Cl. H01M 50/545; H01M 50/107; H01M 50/152; H01M 50/536; H01M 50/538

(52) U.S. Cl. CPC H01M 50/545; H01M 50/107; H01M 50/152; H01M 50/536; H01M 50/538

(57) ABSTRACT

A battery cell that includes grating for coupling to the tabs of the electrodes of the battery cell. Anode and cathode electrodes may be organized as electrode groups. The anode tabs of the anode electrodes of an electrode group may physically contact each other to form an anode tab group. The cathode tabs of the cathode electrodes of an electrode group may physically contact each other to form a cathode tab group. The anode tab group may be positioned through the opening between the bars of the anode grating. The cathode tab group may be positioned through the opening between the bars of the cathode grating. The anode grating and the cathode grating may mechanically and electrically couple to the anode terminal and the cathode terminal of the battery cell.

### BACKGROUND

Embodiments of the present invention relate to rechargeable batteries.

Electric batteries include a plurality of electrodes (e.g., anode, cathode) that need to be assembled with chemistry (e.g., electrolyte) between them so the electrodes can provide a current from the battery or receive a current for recharging the battery. Assembling the electrodes can be time-consuming and costly with respect to the number of connections (e.g., welds) that may be required. Battery manufacturers and users would benefit from structures that make a battery cell assembly easier and less costly.

### SUMMARY

An example embodiment of a battery cell includes a grating (e.g., comb-like structure, comb, lattice) for organizing and holding the tabs of the electrodes during assembly and for providing a surface for physically and electrically coupling the tabs of the electrodes to form the battery cell. The grating can reduce assembly time and improve the connection between the electrodes and the terminals of the battery cell. Improve connections improve the reliability and durability of the battery cell.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a perspective view of an example embodiment of an electrode pack being inserted into an example embodiment of a can.

FIG. 2 is a perspective view of an example embodiment of the battery cell after the electrode pack is inserted into the can.

FIG. 3 is a perspective view of an example embodiment of an assembly frame.

FIG. 4 is a perspective view diagram of anode and cathode electrodes positioned with respect to each other.

FIG. 5 is a front view diagram of anode and cathode electrodes positioned with respect to each other.

FIG. 6 is a perspective view diagram of an electrode group with anode and cathode electrodes positioned with respect to the assembly frame.

FIGS. 7-10 are perspective view diagrams of the assembly frame being used to assemble an electrode pack; however, only the anode electrodes are shown.

FIGS. 11-13 are cross-section diagrams of an example embodiment of the anode grating being positioned with respect to the assembly frame and the electrode groups.

FIG. 14 is a perspective view diagram of the anode grating positioned with respect to the assembly frame and the electrode groups.

FIG. 15 is a perspective view diagram of the assembly frame being withdrawn from the electrode pack.

FIG. 16 is a cross-section view of the example embodiment of the anode grating and the anode electrodes of the electrode groups after withdrawal of the assembly frame and prior to folding the anode tab groups over the bars of the anode grating.

FIG. 17 is a cross-section view of the anode grating with the anode tab groups folded over the bars of the anode grating.

FIGS. 18-21 are diagrams of an example embodiment of a gasket being placed on the can of the battery cell.

FIGS. 22-25 are diagrams of an example embodiment of a sock being placed on the can of the battery cell.

FIG. 26 is a cross-section diagram of the electrode pack with the anode grating and anode tab groups positioned in the can with the gasket and the sock.

FIGS. 27-29 are diagrams showing positioning of the anode terminal on the can and in contact with the sock, the gasket, the anode grating and the anode tab groups.

FIGS. 30-31 are diagrams showing an example embodiment of weld joints for welding the anode terminal to the anode tab groups and the anode grating.

FIGS. 32-33 are diagrams showing an example embodiment of weld joints for welding the anode terminal to the anode tab groups and the anode grating.

FIG. 34 is a perspective view of an example embodiment of a battery pack.

### DETAILED DESCRIPTION

### Overview

An example embodiment of the present disclosure relates to battery cells. In an example embodiment, the battery cell includes an electrode pack (e.g., jellyroll, stack), a can (e.g., canister, housing, body), an anode terminal (e.g., lid) and a cathode terminal (e.g., can).

The electrode pack includes a plurality of anode electrodes and a plurality of cathode electrodes arranged in electrode groups, two gratings (e.g., anode grating, cathode grating) for positioning and connecting to the tabs of the anode electrodes and the cathode electrodes respectively, and chemistry (e.g., electrolyte). The anode electrodes and the cathode electrodes are interleaved with each other with chemistry in between the anode electrodes and the cathode electrodes. The tabs of the anode electrodes are oriented in one direction (e.g., up) while the tabs of the cathode electrodes are oriented in another direction (e.g., down). The tabs of the anode electrodes mechanically and electrically coupled to one of the gratings (e.g., anode grating) while the tabs of the cathode electrodes mechanically and electrically coupled to the other grating (e.g., cathode grating).

In an example embodiment, the can is open at both ends. A gasket and a sock are positioned around each opening respectively. The gaskets electrically insulate the electrode pack from the can. While the anode terminal connects to one end of the can and the cathode terminal connects to the other end of the can, the gasket allows the anode terminal to connect to the anode electrodes of the electrode pack and the cathode terminal to connect to the cathode electrodes of the electrode pack, but neither terminal electrically connects to the can.

In another example embodiment, the can is open at only one end. Further, the can is formed of an electrically conductive material. When the electrode pack is positioned in the can, one polarity of electrode (e.g., cathode) is brought into physical and electrical contact with the can, so the can itself becomes the terminal for that polarity of electrode. The other polarity of electrode (e.g., anode) comes into contact with the gasket positioned around the opening of the can. The gasket insulates the other polarity of electrode from the can. A terminal (e.g., lid), which is also electrically conductive, is placed over the opening and brought into mechanical and electrical contact with the other polarity of electrodes (e.g., anode). In an example embodiment, the anode electrodes couple to the lid which forms the anode terminal. The gasket insulates the anode terminal and the anode electrodes from the can. The cathode electrodes come into contact with the can (e.g., bottom of the can), so that the can itself forms the cathode terminal. Because the gasket insulates the anode electrodes and the anode terminal from the can, the anode electrodes do not form a short circuit with the cathode electrodes.

In an example embodiment, the electrode pack is assembled separately from and outside of the can. Once the electrode pack is assembled, it is inserted into the can to position the anode grating inside the sock of opening and the cathode grating in contact with the bottom of the can. After positioning the electrode pack in the can, the anode terminal (e.g., lid) is positioned over the anode end of the battery pack and connected to the sock, the anode grating and the tabs of the anode electrodes.

In an example embodiment, the electrode pack is assembled using an assembly frame. The assembly frame includes at least one end wall, at least four rods, and a plurality of retention bars. Electrode groups are positioned with respect to the assembly frame and retention bars are used to position and hold the tabs of the electrode groups in position. An electrode group includes anode and cathode electrodes interleaved with each other with chemistry in between the electrodes. An electrode group may include between six electrodes (e.g., 3 anode electrodes, 3 cathode electrodes, 3 electrode pairs) and 32 electrodes (e.g., 16 anode electrodes, 16 cathode electrodes, 16 electrode pairs), preferably 18 electrodes (e.g., nine anode electrodes, nine cathode electrodes, nine electrode pairs). In each electrode group, the anode and cathode electrodes are interleaved with chemistry (e.g., electrolyte) between or on each electrode.

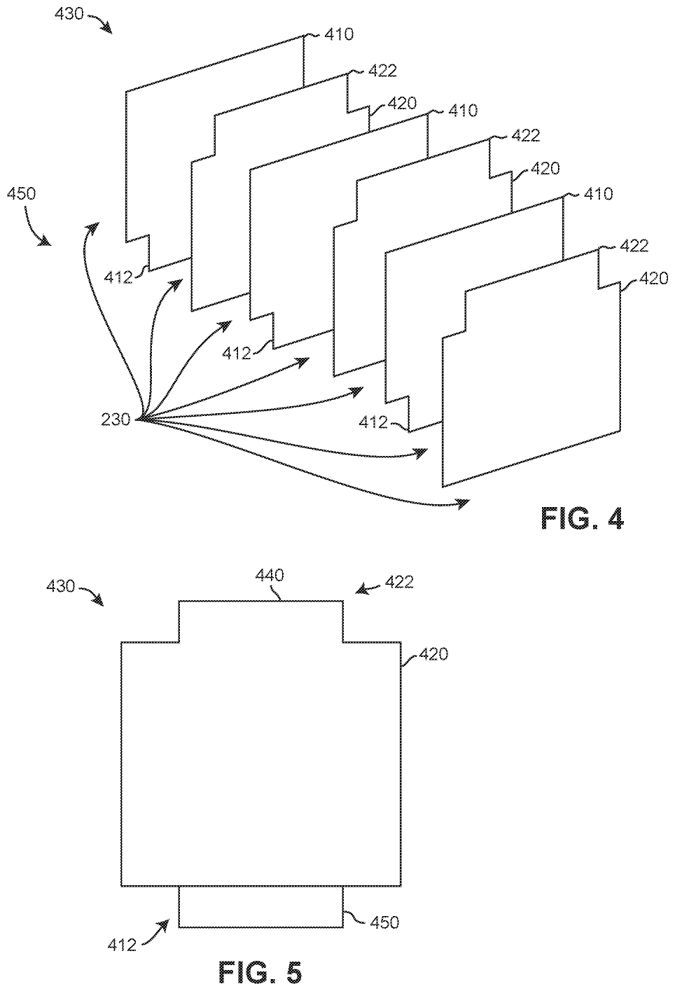

All of the tabs of the anode electrodes of an electrode group are oriented in the same direction and all of the tabs of the cathode electrodes of the electrode group are oriented in the same direction; however, the directions of orientation of the anode tabs and the cathode tabs are different. For example, in an example embodiment of an electrode group, as best shown in FIGS. 4-6, the tabs of the anode electrodes are oriented upward while the tabs of the cathode electrodes are oriented downward. In another example embodiment, the tabs of the anode electrodes are oriented upward, while the tabs of the cathode electrodes are oriented with at least a 90-degrees offset (e.g., left, right) from the orientation of the anode electrodes.

The tabs of the anode electrodes of electrode group are positioned to mechanically and electrically contact each other and may be referred to as an anode tab group. The tabs of the cathode electrodes of the electrode group are positioned to mechanically and electrically contact each other and may be referred to as a cathode tab group. As the electrode groups are positioned in the assembly frame, the retention bars are used to hold the electrode and cathode tab groups in position.

Once all of the electrode groups are positioned in the assembly frame, the anode grating is positioned in the assembly frame so that the anode tab groups are positioned in the openings (e.g., spaces, channels) between the bars (e.g., teeth, latticework, lines) of the anode grating. Likewise, the cathode tab groups are positioned in the openings between the bars of the cathode grating. The assembly frame is then removed (e.g., withdrawn, extracted, separated) from the electrode groups leaving the electrode groups, the anode grating and the cathode grating as a unit referred to herein as the electrode pack. In the electrode pack, the anode tab groups are positioned with respect to the anode grating and the cathode tab groups are positioned with respect to the cathode grating. The anode tab groups are then folded over the bars of the anode grating and the cathode tab groups are folded over the bars of the cathode grating. Folding the anode tab groups and the cathode tab groups over the bars of the anode grating and the cathode grating respectively electrically and mechanically couples the anode electrodes to the anode grating in the cathode electrodes to the cathode grating. At this point, the electrode pack is ready to be inserted into the can.

### A Note Regarding the Drawing

The chemistry (e.g., electrolyte) between the anode and cathode electrodes is not expressly shown in any figure of drawing; however, the position of the chemistry relative to anode and cathode electrodes is shown in FIG. 4. Generally, the electrolyte is in contact with at least one side of each electrode and more likely in contact with both sides of each electrode.

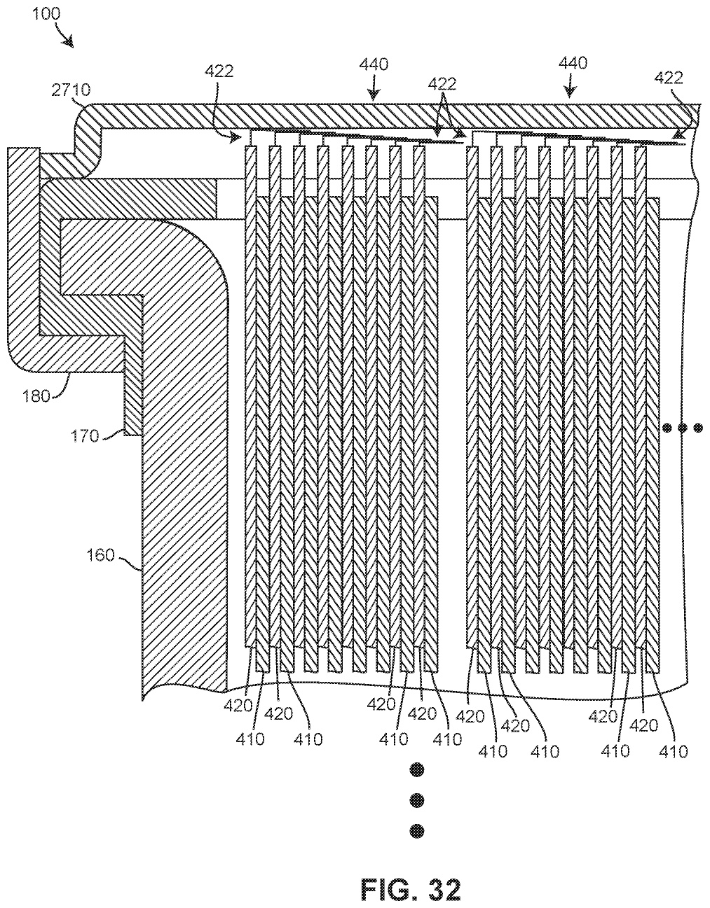

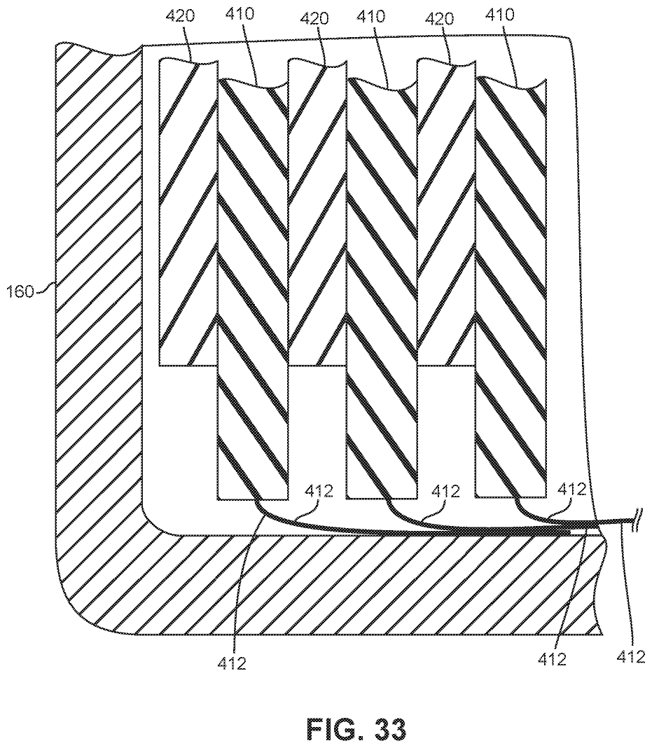

Anode and cathode electrodes are shown in FIG. 4-6. In all other figures, except for FIGS. 32 and 33, only the anode electrodes are shown. The cathode electrodes are omitted for clarity of presentation. In actuality, the battery cell, the electrode pack and the electrode groups include anode electrodes, anode tabs, and anode grating, cathode electrodes, cathode tabs and a cathode grating even though the cathode electrodes, cathode tabs and cathode grating are not shown.

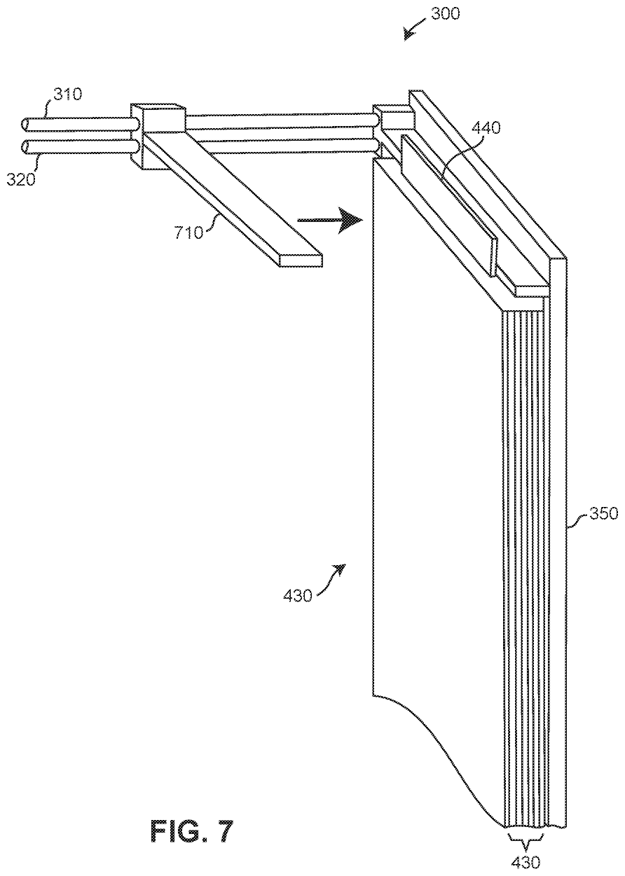

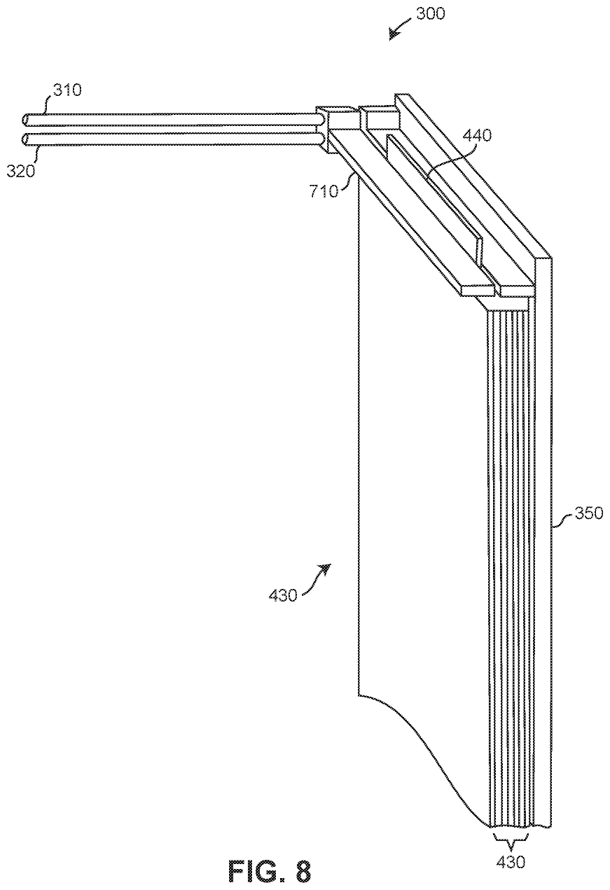

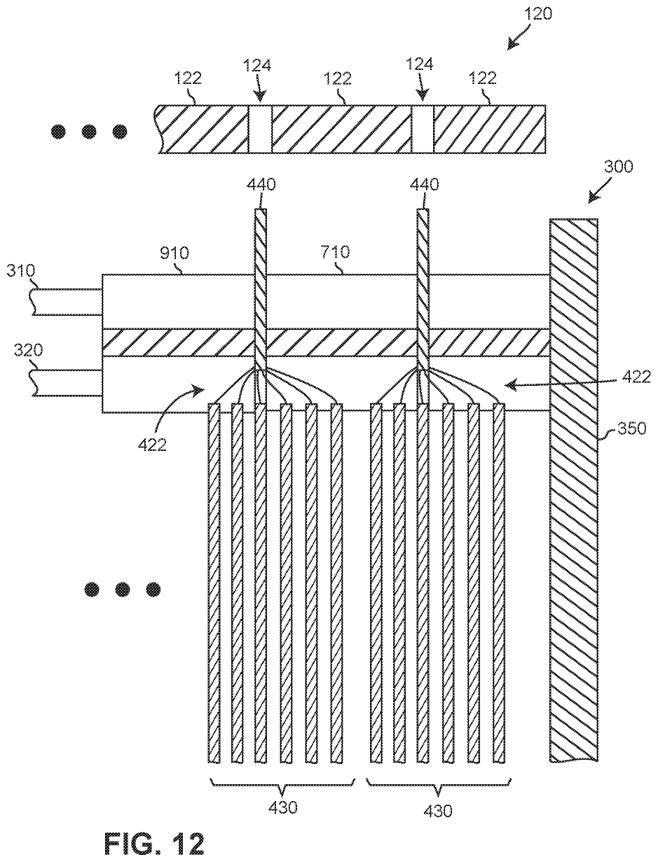

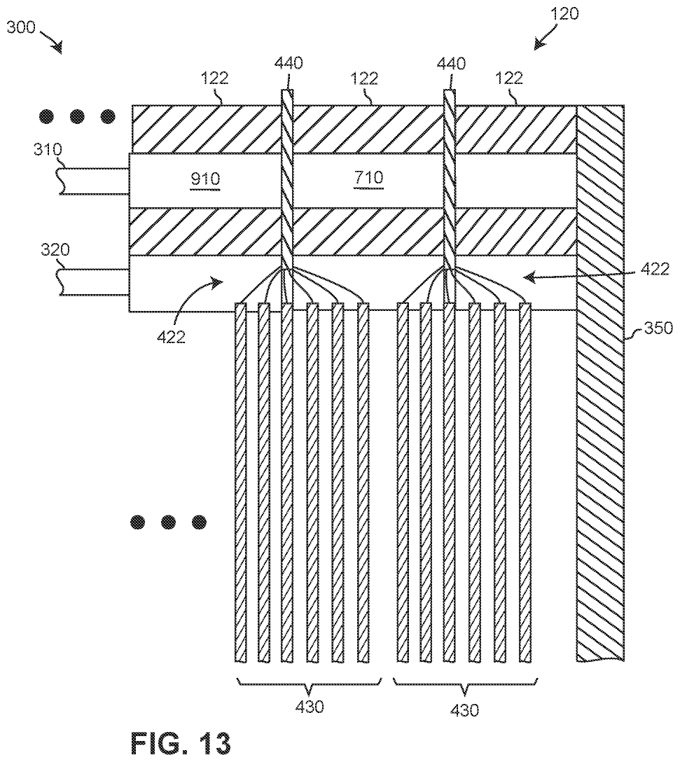

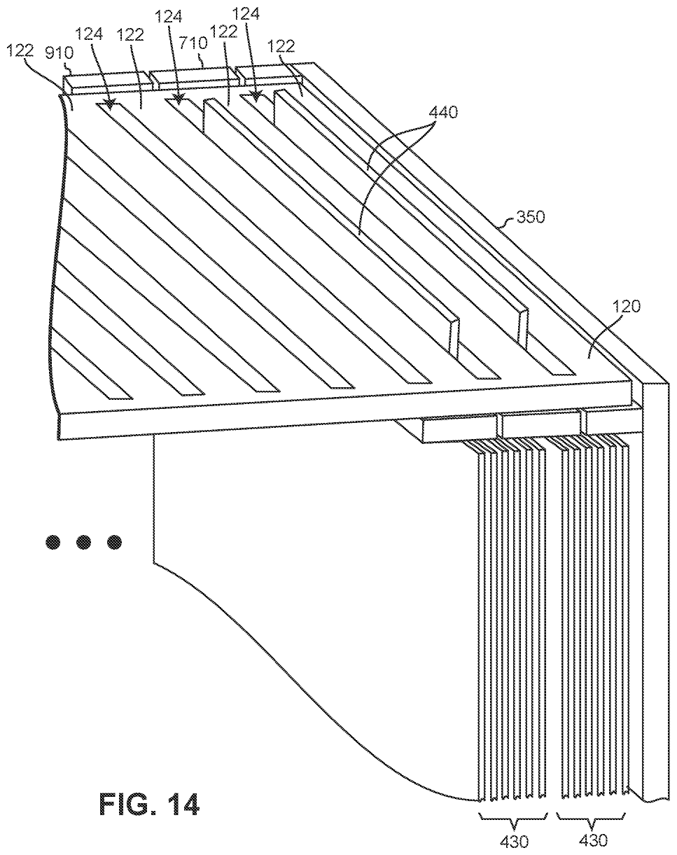

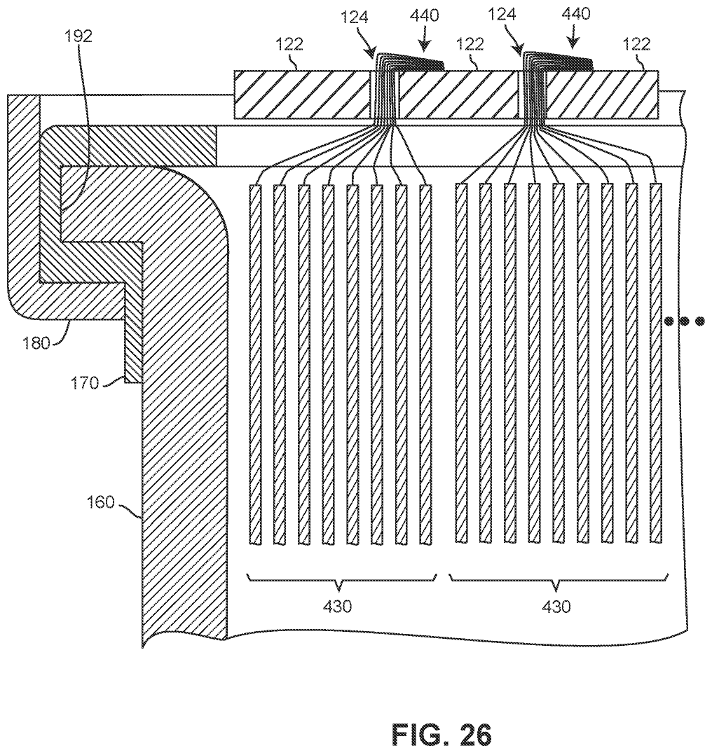

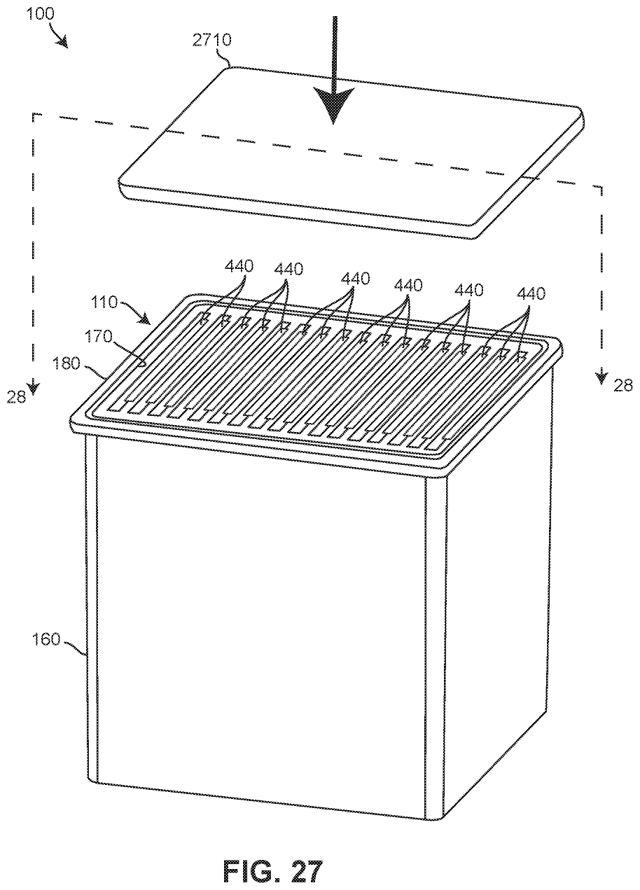

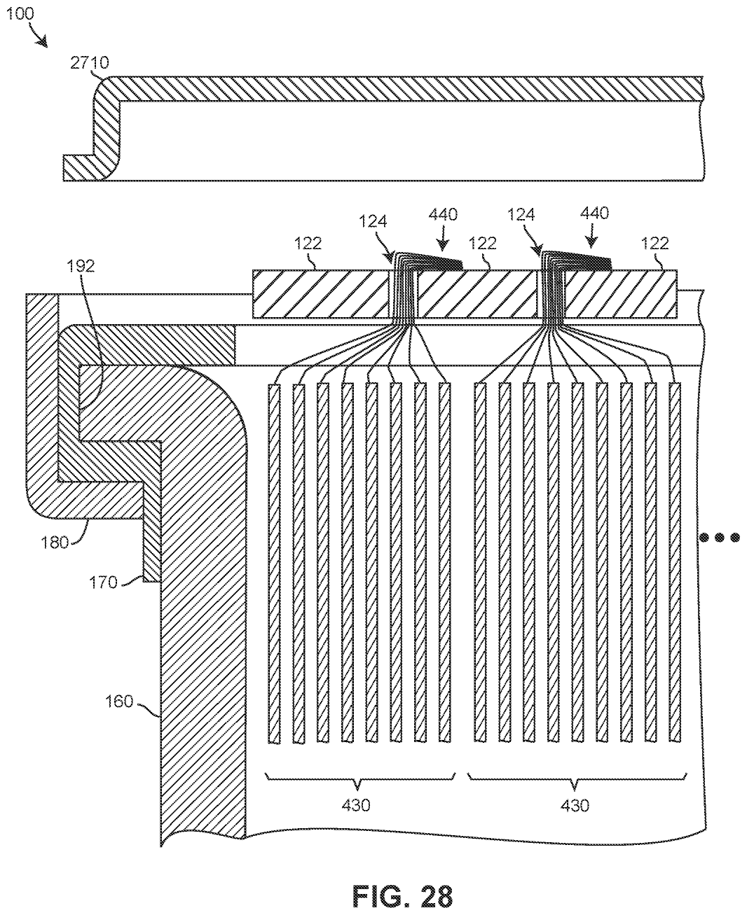

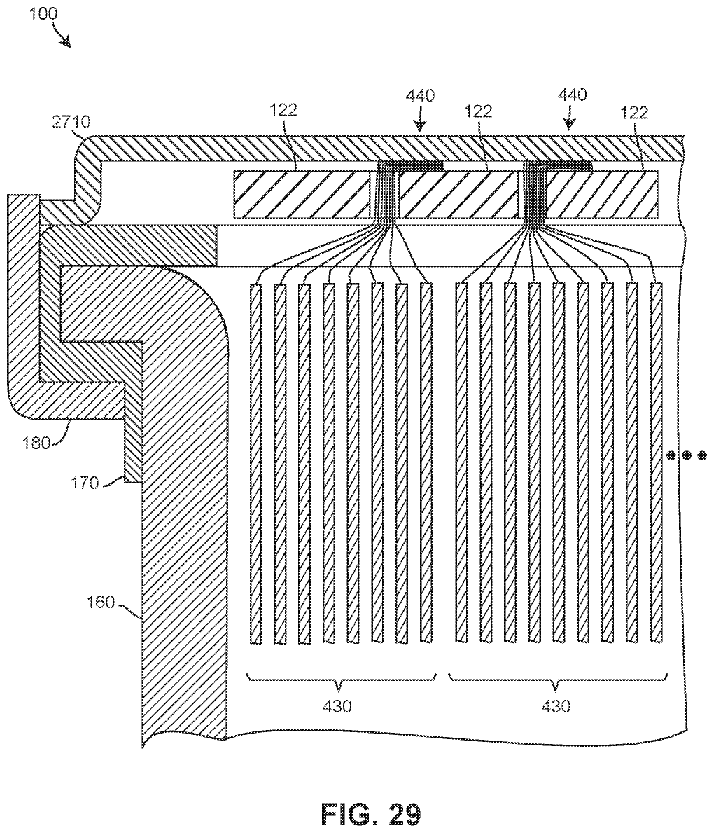

Also, in FIGS. 7-17 and 26, 28-30 and 32 at most two electrode groups are shown for the sake of brevity; however, a battery pack contains more electrode packs.

### Assembling the Electrode Pack

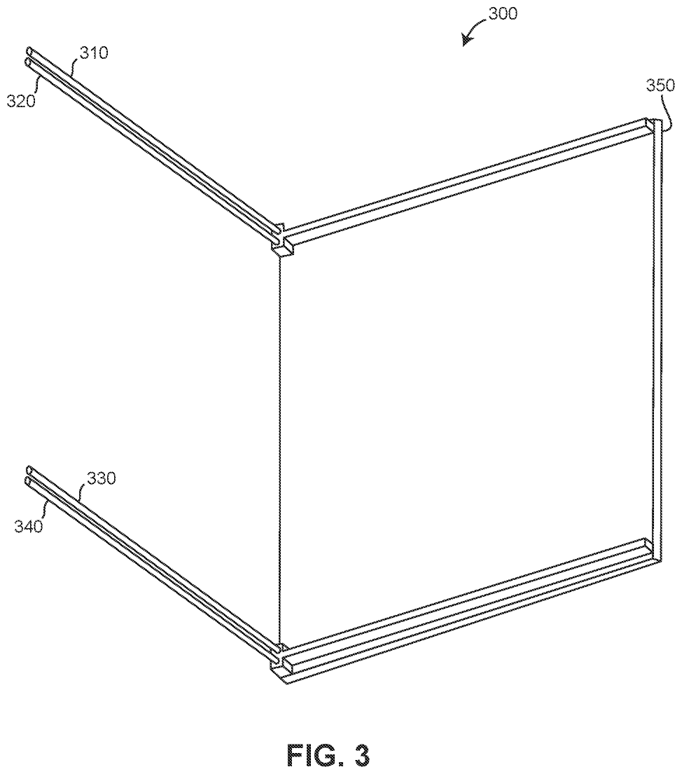

As discussed above, an assembly frame is used to assemble the electrode pack. In an example embodiment, assembly frame 300, as best shown in FIGS. 3 and 6-15, is used to assemble the electrode pack (e.g., jellyroll, stack) 110. The assembly frame 300 includes end wall 350, rod 310, rod 320, rod 330, rod 340 and a plurality of retention bars (e.g., 710, 910).

Assembly of the electrode pack 110 begins with assembling a plurality of electrode groups 430. An electrode group 430 includes a plurality of anode electrodes 420, a plurality of cathode electrodes 410 and chemistry 230.

As best seen in FIGS. 4-6, each electrode, whether anode electrode or cathode electrode, includes a body and a tab. The tab extends from the body. In an example embodiment, the tab is not as wide as the body. The tab has less area than the body. For example, cathode electrode 410 includes a body 414 and tab 412. Anode electrode 420 includes body 424 and tab 422.

When assembling an electrode pack 110, as best seen in FIGS. 4-6, anode electrodes 420 are alternately positioned (e.g., interleaved) with cathode electrodes 410 while the chemistry 230 is positioned in between anode electrodes 420 and cathode electrodes 410 as indicated in FIG. 4. As discussed above, the electrode group 430 may include between 3 to 16 anode electrodes 420 and 3 to 16 cathode electrodes 410. In an example embodiment, electrode group 430 includes 9 anode electrodes 420 and 9 cathode electrodes 410. The chemistry 230 is positioned between the anode electrodes 420 and the cathode electrodes 410 and on a surface of the electrodes at the end of the electrode group 430. In the example embodiment shown in FIG. 4, three anode electrodes 420 are interleaved with three cathode electrodes 410. The plurality of electrodes and chemistry assembled to form an electrode group may be assembled (e.g., place) either manually, using a machine, or a combination thereof.

As best shown in FIGS. 4-6, the anode tab 422 of each anode electrode 420 is positioned in one direction (e.g., upward) while the cathode tab 412 of each cathode electrode 410 is positioned in another direction (e.g., downward). The anode tabs 422 of electrode group 430 are positioned (e.g., bent, folded) to touch each other to form anode tab group 440. The cathode tabs 412 of electrode group 430 are positioned to touch each other to form cathode tab group 450. Positioning the anode tabs 422 to touch each other electrically couples the anode tabs 422 to each other. Electrically coupling the anode tabs 422 to each other electrically couples the anode electrodes 420 to each other in parallel. Positioning the cathode tabs 412 to touch each other electrically couples the cathode tabs 412 to each other. Electrically coupling the cathode tabs 412 to each other electrically couples the cathode electrodes 410 to each other in parallel. The electrodes with their tabs are formed of a conductive material.

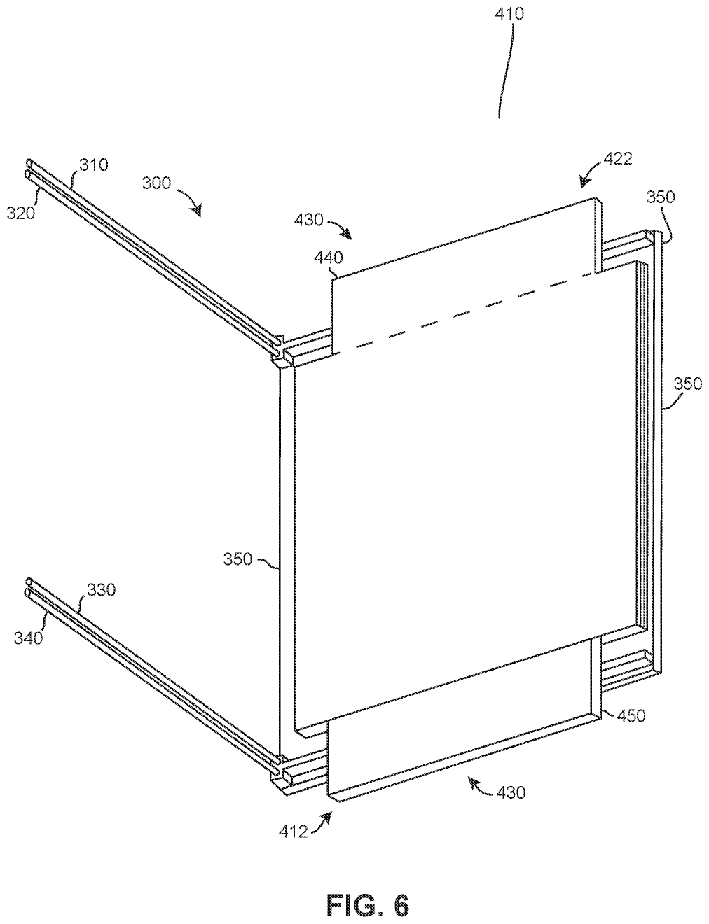

An assembled electrode group 430 may then be positioned with respect to the assembly frame 300 as shown in FIG. 6. As shown in FIG. 6, the first electrode group 430 of electrode pack 110 has been positioned with respect to assembly frame 300.

The electrode pack 110 is assembled by positioning a first electrode group 430 with respect to the assembly frame 300. A first retention bar 710, as shown in FIG. 7, is slidably coupled to rods 310 and 320 and moved (e.g., slid) toward the first electrode group 430 until the first retention bar 710, as best shown in FIGS. 7-13, is proximate to the anode tab group 440. The retention bar 710 is adapted to position and hold the anode tab group 440 in place.

As discussed above, for clarity of the figures, only the anode electrodes 420, the anode tabs 422 and/or anode tab groups 440 are shown in the FIGS. 7-17 and 26-30. All of the assembly steps discussed herein with respect to the anode electrodes 420, the anode tab groups 440 and the anode grating 120 are also performed for the cathode electrodes 410, the cathode tab groups 450 and the cathode grating 130. Rods 330 and 340 slidably receive retention bars (e.g., 710, 910) for positioning and holding cathode tab groups 450 of the electrode groups 430.

A grating has a first side (e.g., bottom), a second side (e.g., top), a plurality of bars and an opening between the bars. The openings go through the grading and are open on the first side and the second side. The openings separate the bars. In an example embodiment, the grating is formed of a single piece of material with the openings cut through the material to form the bars. The openings allow an object (e.g., electrode tabs) to enter the opening on one side (e.g., bottom) of the grating and pass through the grating to the other side (e.g., top) so that the electrode is positioned on the first side of the grading and a portion of the electrode tab is positioned in the opening and on the second side of the grating. The electrode tab of one or more electrodes may be positioned in the opening between bars. The electrode tab of anyone electrode is positioned in only one opening of the grating. At least one tab is positioned in each opening. In an example embodiment, the tabs of electrodes are evenly distributed between the openings. The bars of a grating may be parallel to each other. In another example embodiment, the grading includes a first rail and the second rail and the plurality of bars. A first end of each bar connects to the first rail. A second end of each bar connects to the second rail. The bars are positioned to have a opening between the bars. The bars are parallel to each other. Preferably, the grating is formed of a conductive material.

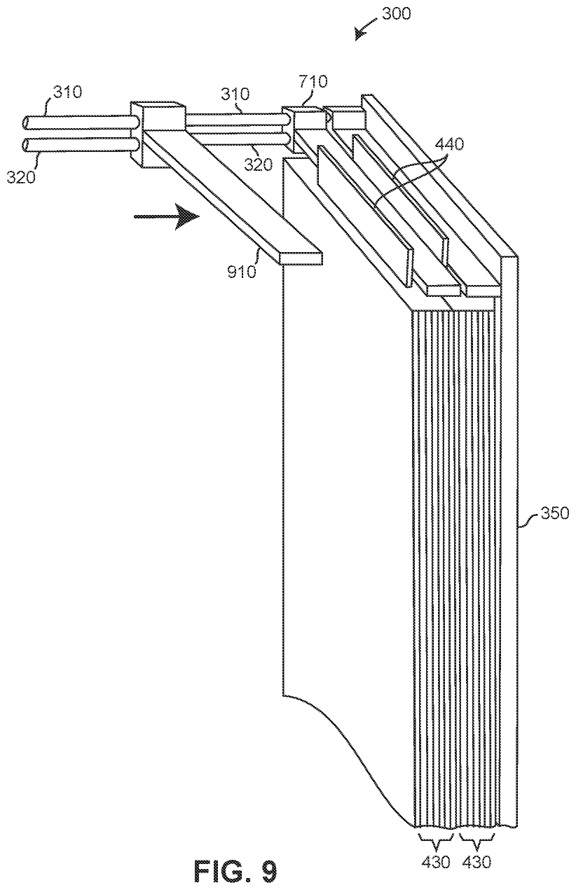

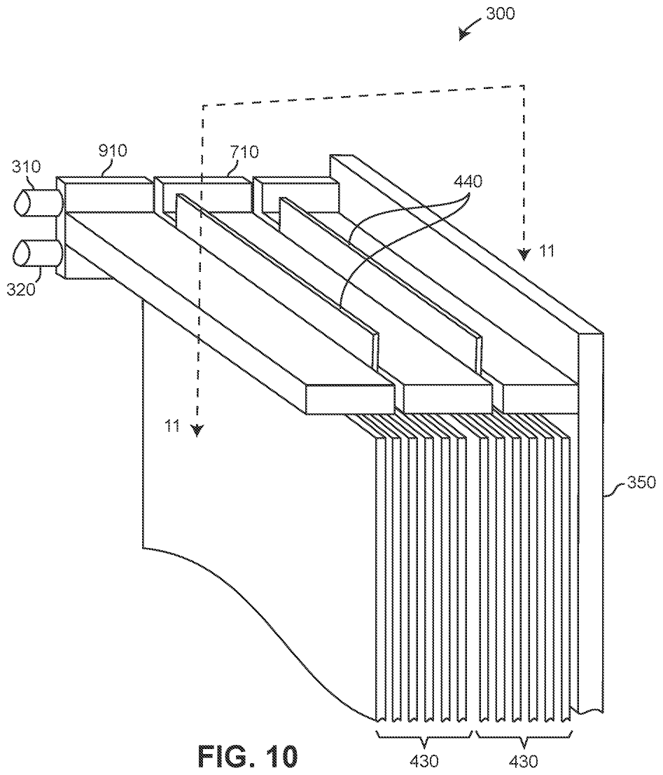

Once the first retention bar 710 is in position, a second electrode group 430, as best shown in FIG. 9, is positioned proximate to the first electrode group 430. The chemistry 230 may be positioned between the end electrodes of the first electrode group 430 and the second electrode group 430. A second retention bar 910, as best shown in FIG. 9, is slidably coupled to the rods 310 and 320 and moved toward the second electrode group 430 until it is proximate to the anode tab group 440 of the second electrode group 430, as best shown in FIGS. 10-13. Like the first retention bar 710, the second retention bar 910 is adapted to position and hold the anode tab group 440 of the second electrode group 430 in place.

Additional electrode groups 430 and retention bars (e.g., 710, 910) are positioned with respect to each other and with respect to the assembly frame 300 to form the electrode pack 110. The electrode pack 110 may include between 2 to 30 electrode groups 430. In an example embodiment, the electrode pack 110 includes 19 electrode groups 430. Each electrode group 430 includes nine anode electrodes 420 and nine cathode electrodes 410, so in this example embodiment, the electrode pack includes 171 anode electrodes 420 and 171 cathode electrodes 410. Each anode tab group 440 includes nine anode tabs 422. Each cathode tab group 450 includes nine cathode tabs 412. The plurality of electrode groups assembled to form an electrode pack, including placement of the electrode groups and the retention bars, may be assembled either manually, using a machine or a combination thereof.

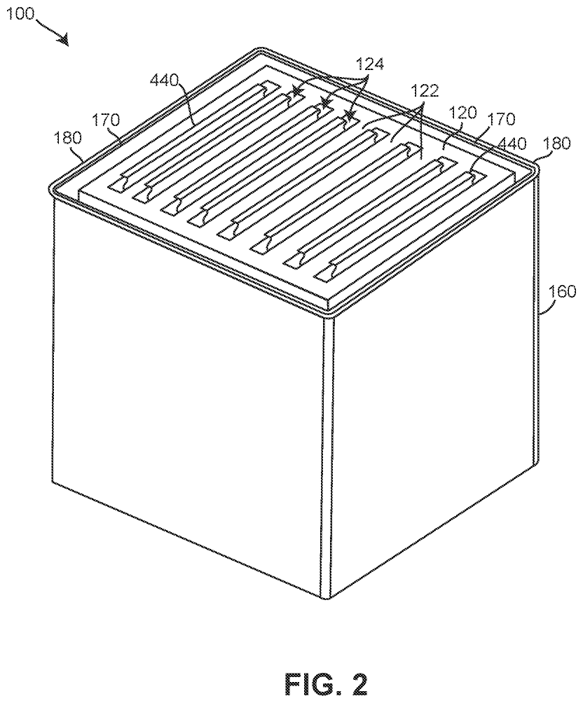

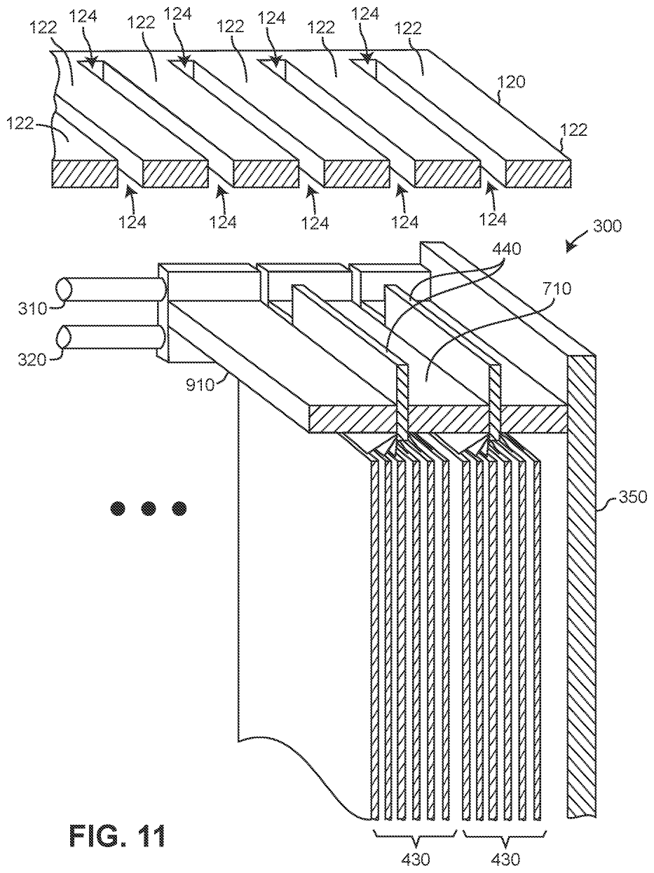

Once all of the electrode groups 430 and retainer bars (e.g., 710, 910) are positioned with respect to the assembly frame 300, a grating (e.g., anode grating 120, cathode grating 130), as best shown in FIGS. 11-14, may be positioned with respect to the assembly frame 300 and the tab groups (e.g., anode tab groups 440, cathode tab groups 450). Although the FIGS. 2, 11-17 and 26-30 show only the anode grating 120, similar assembly is performed with respect to the cathode grating 130. The anode grating 120, as with the cathode grating 130, includes a plurality of bars (e.g., bars 122) and an opening 124 between each bar 122.

As the anode grating 120 is positioned with respect to the assembly frame 300 and the anode tab groups 440, the anode grating 120 is adapted to position the anode tab groups 440 in respective openings 124 of the anode grating 120. As the anode grating 120 is positioned above the assembly frame 300, the openings 124 respectively aligned with the anode tab groups 440, so that a single anode tab group 440 is aligned with a single opening 124. As the anode grating 120 is moved toward and onto the assembly frame 300, the respective anode tab groups 440 move through the respective opening 124 so that each anode tab group 440 is positioned in one respective opening 124.

After placement of the anode grating 120 with respect to the assembly frame 300, each anode tab group 440 is positioned between two retainers (e.g., 710, 910) and through one opening 124 of the anode grating 120. Because each anode tab group 440 is positioned through one respective opening 124, each anode tab group 440 is positioned proximate to two bars 122, one bar 122 on each side.

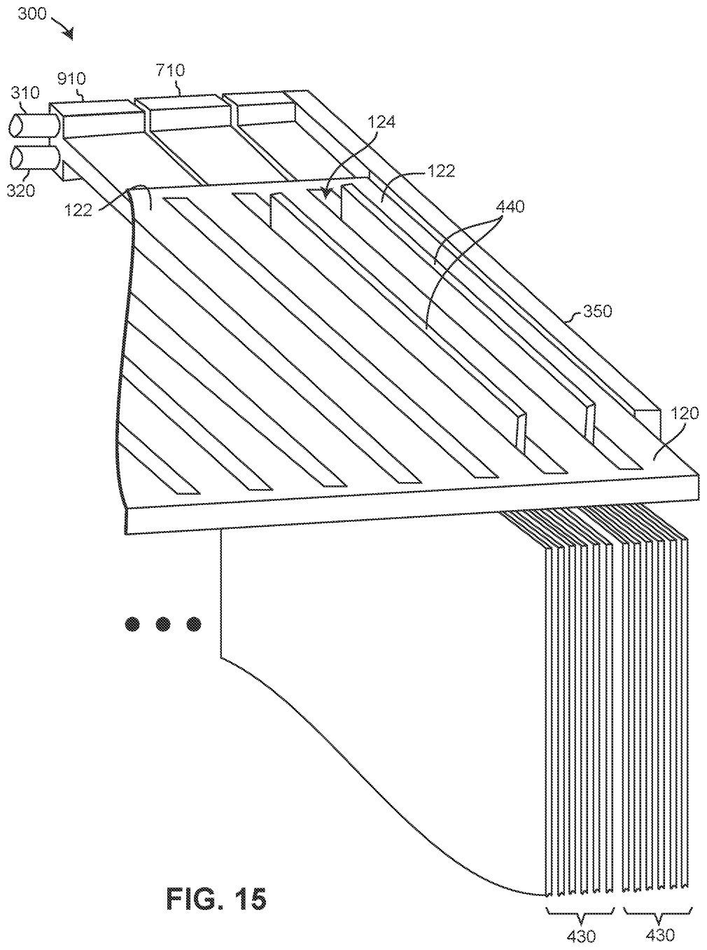

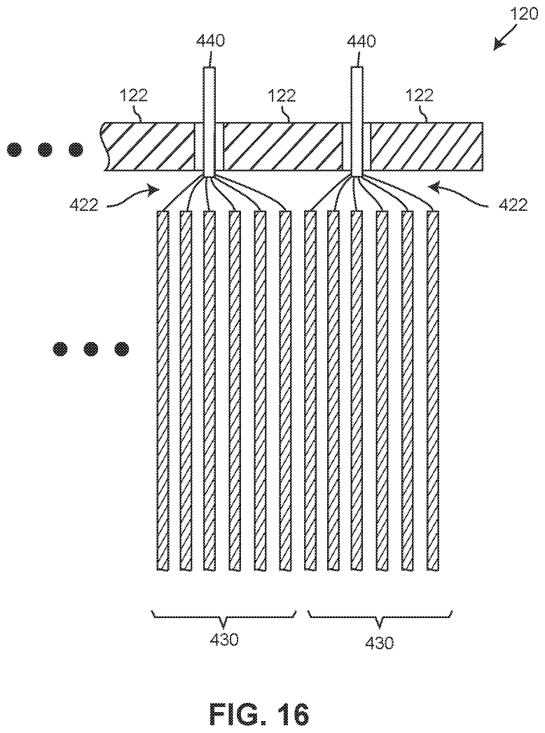

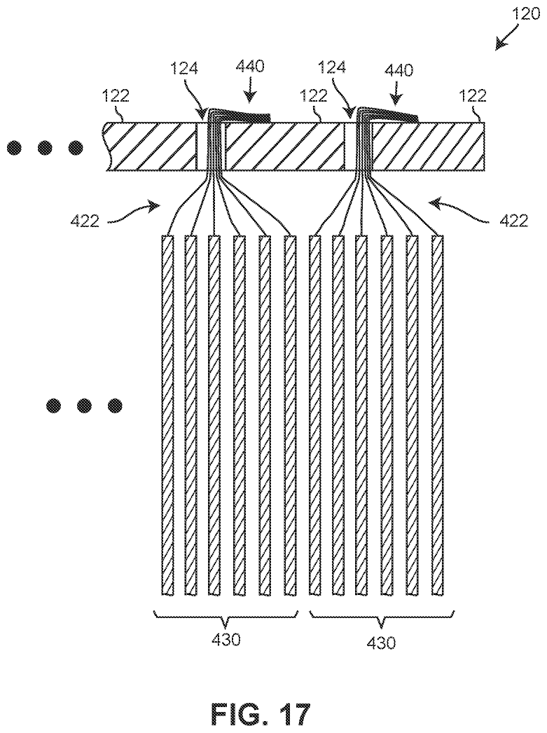

After the gratings (e.g., anode grating 120, cathode grating 130) have been moved into position with respect to the assembly frame 300 and the electrode groups 430, the assembly frame 300 may be removed (e.g., withdrawn, extracted, move away) from the electrode groups 430. In an example embodiment, as best shown in FIG. 15, the assembly frame, including the end wall 350, the rods 310-340, and all the retention bars (e.g., 710, 910) are pulled away from the electrode groups 430 that form the electrode pack 110. The assembly frame 300 is completely removed from the electrode groups 430 to leave only the electrode pack 110. As the assembly frame 300 is being withdrawn, the anode tab groups 440 and cathode tab groups 450 remain positioned through the respective openings (e.g., 124) of their respective gratings (e.g., anode grating 120, cathode grating 130). As best shown in FIG. 16, after removal of the assembly frame 300, the anode tab groups 440, and the cathode tab groups 450, though not shown, are positioned through respective openings 124 of anode grating 120 and the cathode grating 130 respectively. Each anode tab group 440 is then folded (e.g., bent) over, as best shown in FIGS. 17, 26-30, to come into contact with a proximate bar 122 of the anode grating 120. The same type of folding occurs with the cathode tab groups 450 of each electrode group 430.

Folding the anode tab groups 440 so that they come into contact with the bar 122 of the anode grating 120 establishes electrical contact between the anode electrode 420 of each electrode group 430. In other words, folding the anode tab groups 440 mechanically and electrically couples each anode electrode 420 to the anode grating 120. In an example embodiment, the anode grating 120 is formed of a conductive material (e.g., metal), so that folding the anode tab groups 440 establishes a parallel electrical connection between all of the anode electrodes 420. The cathode tab groups 450 are similarly folded to come into contact with the cathode grating 130, so that a parallel connection between all of the cathode electrodes 410 is established.

At this point in assembling the example embodiment, the electrode pack 110 has been assembled and is ready to be inserted into the can 160 and to be connected to terminals (e.g., anode terminal 2710, cathode terminal which is can 160). However, prior to inserting the electrode pack 110 into the can 160, the can 160 must be prepared to receive the electrode pack 110 and to establish the terminals.

### Preparing the Can

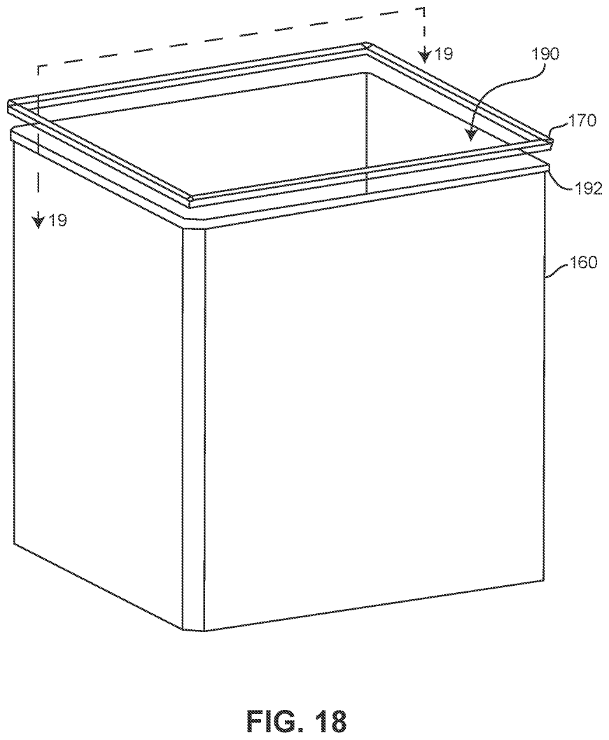

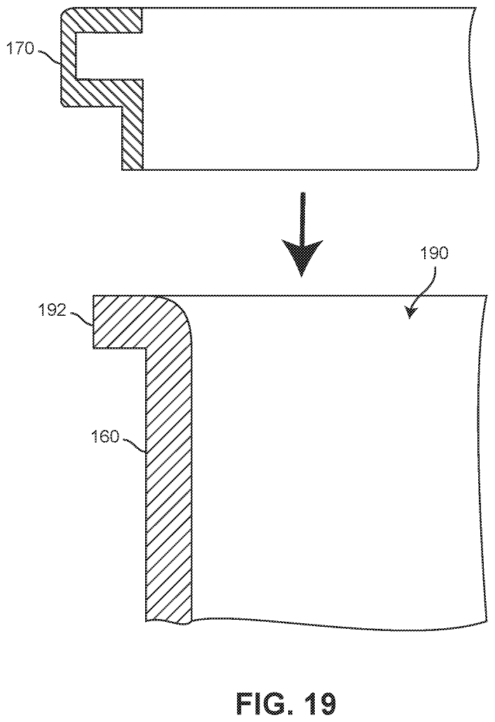

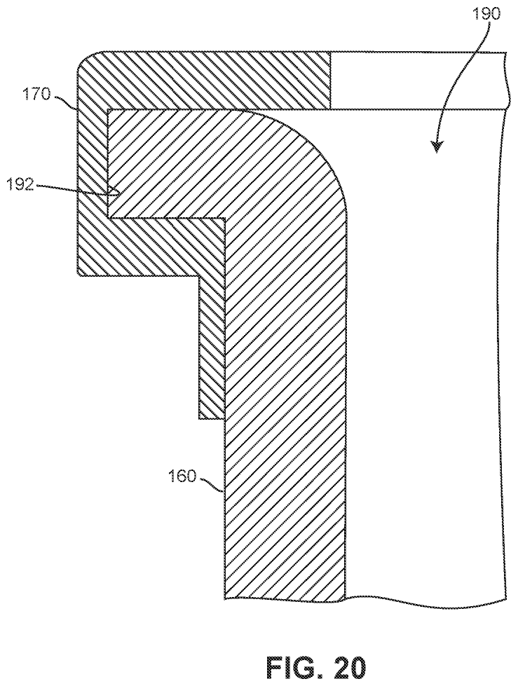

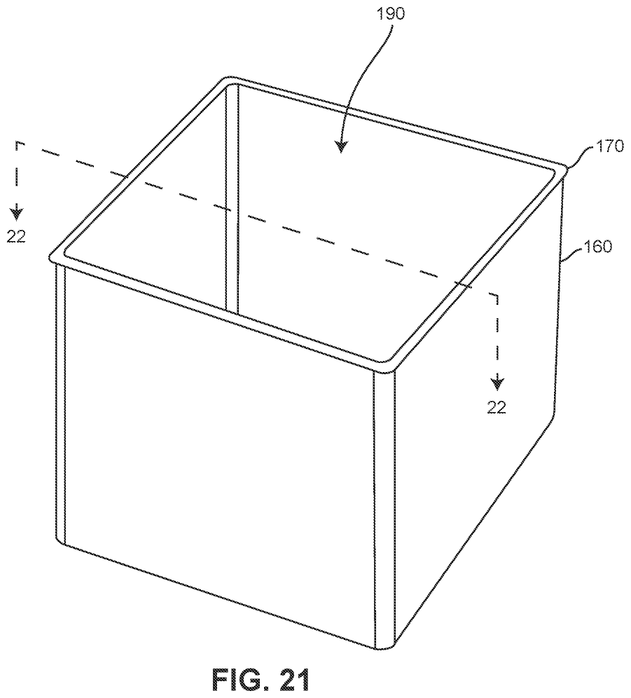

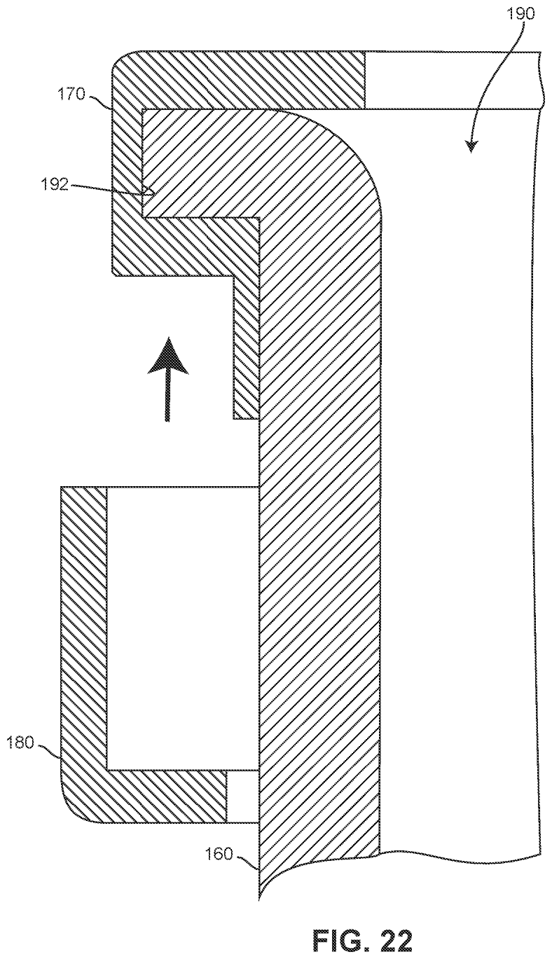

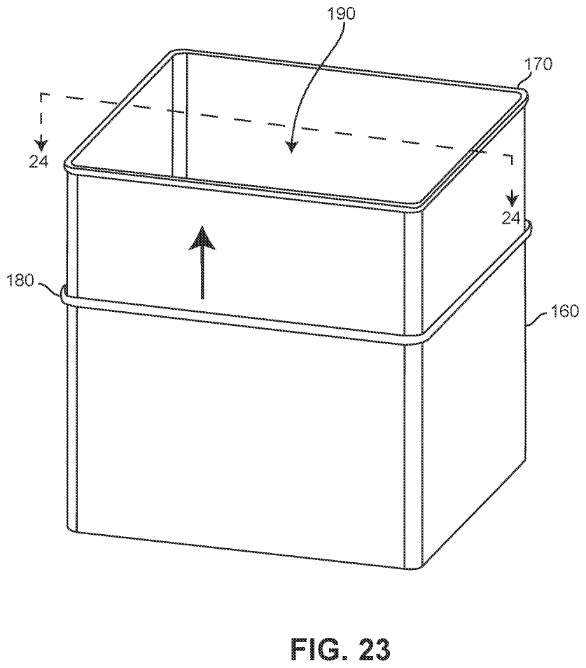

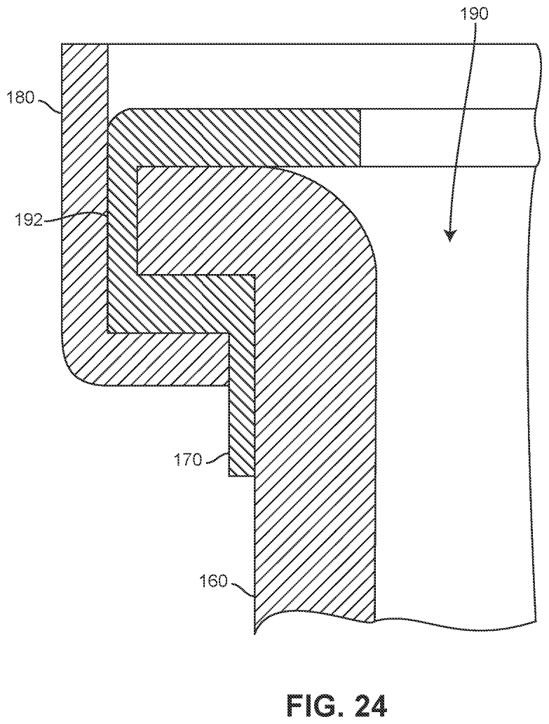

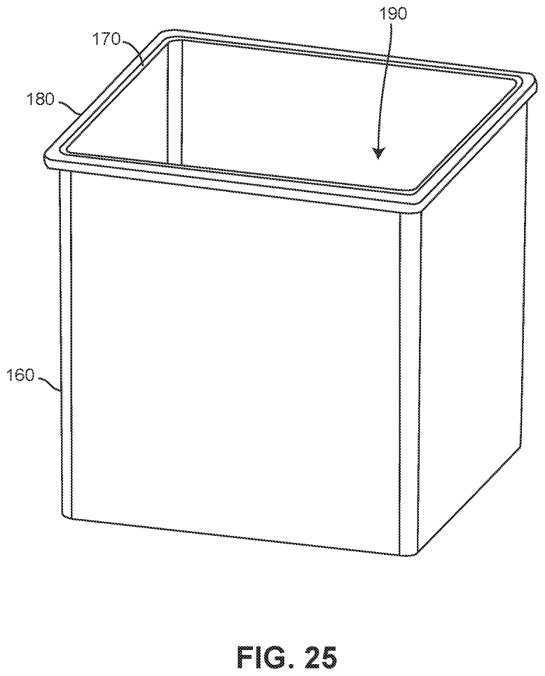

As discussed above, the can 160 holds the electrode pack 110. In an example embodiment, the can 160 includes the opening 190 through which the electrode pack 110 is inserted. In the example embodiment, the can 160 is formed of a conductive material (e.g., metal). As best seen in FIG. 21, the can 160 includes a lip 192 around the opening 190. As best shown in FIGS. 18-22, 24, 26, 28-30 and 32, the gasket 170 is placed around the opening 190 and over the lip 192. The gasket 170 is formed of an electrical insulator (e.g., rubber, plastic). In other words, the gasket 170 is formed of a material that reduces significantly or completely stops the flow of an electrical current. The sock (e.g., cover, ring) 180 is placed over and around the gasket 170. As best shown in FIGS. 24, 26 and 28-30, the gasket 170 electrically insulates the sock 180 from the can 160. The sock 180 is formed of a conductive material (e.g., metal). When the anode terminal 2710 (e.g., lid) is placed over the can 160, the anode grating 120 and the anode tab groups 440 come into physical and electrical contact with the anode terminal 2710. The anode terminal 2710 further comes into physical and electrical contact with the sock 180. However, since the sock 180 is electrically insulated from the can 160, the anode terminal 1270, the anode tab groups 440 and the anode grating 120 do not come into electrical contact with the can 160. So, the can 160 function as the cathode terminal while the anode terminal 1270 and the sock 180 function as the anode terminal of the battery cell 100.

Once the gasket 170 and the sock 180 have been positioned on and around the opening 190 of the can 160, the electrode pack 110 may be inserted into the can 160.

Inserting the Electric Pack into the can

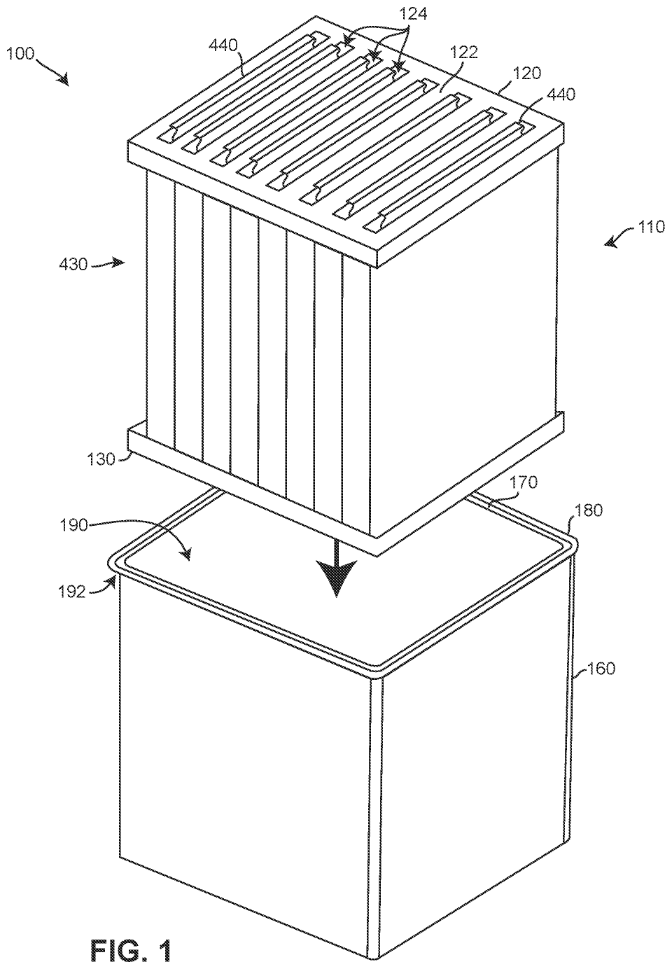

After the electrode pack 110 has been assembled and the can 160 prepared, the electrode pack 110 may be inserted into the can. The electrode pack 110, as best shown in FIG. 1, may be inserted into the can 160 by lowering the electrode pack 110 into the can 160 through the opening 190. In an example embodiment, the cathode grating 130 and cathode tab groups 450 are positioned on the bottom of the electrode pack 110. The bottom of the electrode pack, and therefore the cathode grating 130 and the cathode tab groups 450, come into physical and electrical contact with the bottom of the can 160. Because the can 160 is formed of a conductive material, contact of the cathode grating 130 and the cathode tab groups 450 with the can 160 causes the can 160 to become cathode terminal of the battery cell 100.

The anode grating 120 and the anode tab groups 440 are positioned in the opening 190 of the can 160, but do not contact the can 160. The anode terminal 2710, much like a lid for the can 160, is positioned to cover the opening 190 of the can 160 and to retain the electrode pack 110 inside the can 160. Positioning the anode terminal 2710 over the opening 190 brings anode terminal 2710 into contact with the sock 180, the anode grating 120 and the anode tab groups 440. Contact of the anode terminal 2710 and sock 180 with the anode grating 120 and the anode tab groups 440 causes the anode terminal 2710 and the sock 182 become the anode terminal of the battery cell 100. As discussed above, the gasket 170 insulates the anode terminal (e.g., anode terminal 2710, sock 180, anode grating 120, the anode tab groups 440) from the cathode terminal (e.g., can 160) of the battery cell 100.

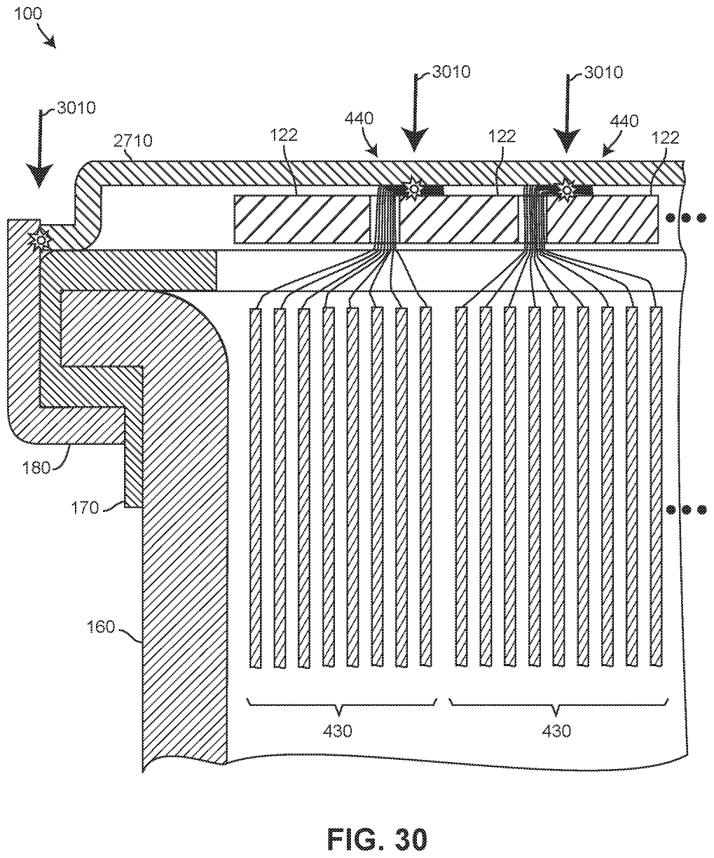

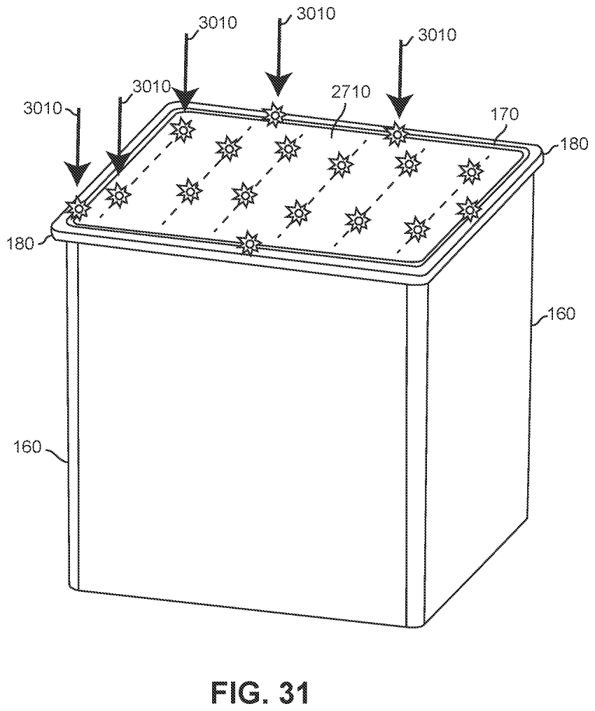

In an example embodiment, as best shown in FIGS. 30-31, the anode terminal 2710 is welded (e.g., spot weld 3010) to the sock 180, the anode grating 120, and the anode tab groups 440. Welding the anode terminal 2710 to the sock 180 retains the anode terminal 2710 connected to the can 160 through interference between the sock 180, the gasket 170 and the lip 192. The anode terminal 2710 further presses down on the electrode pack 110 to press cathode grating 130 and the cathode electrode groups 450 into physical and electrical contact with the bottom of the can 160. The anode terminal 2710 is welded to the anode grating 120 and the anode tab groups 440 to electrically couple the anode electrodes 420 to the anode terminal 2710.

### Battery Cell and Battery Pack

Once assembled, the battery cell 100 may be used provide electrical energy to electrical and/or electronic devices and to receive electrical energy to recharge the battery cell 100. A plurality of battery cells 100 may be used to form a battery pack 3400.

In an example embodiment, battery pack 3400 is formed of two or more battery cells 100. The battery cells 100 may be connected in series with each other and/or in parallel with each other. In an example embodiment, the battery cells 100 are connected to each other by welding (e.g., spot welding) the anode terminal 2710 or the sock 180 of one battery cell 100 to the anode terminal 2710 or the sock 180 of one or more other battery cells 100. The anode terminals 2710 or the socks 180 other battery cells 100 may be welded to each other to form series or parallel electrical connections. Welding the anode terminals 2710 or the socks 180 to each other forms the anode terminal 3410 of the battery pack 3400. The cans 160 of the battery cells 100 are also welded to each other, in series or in parallel, to form the cathode terminal 3420 of the battery pack 3400.

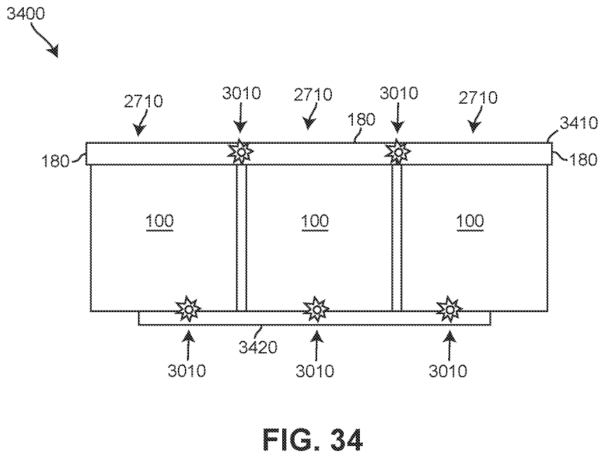

As best shown in FIG. 34, the cans 160 of the battery cells 100 may be placed proximate to each other so they may be welded to each other to establish a physical and electrical connection. Welding the cans 160 of the battery cells 100 to each other, whether in series or in parallel, saves time during assembly and reduces the amount of material needed to form the anode terminal.

### Compact Battery Cell

The size of the battery cell 100, and therefore the can 160, may be made smaller by omitting the grating (e.g., 120, 130) as best shown in FIGS. 32-33. The anode tabs 422 that were grouped together are folded over the top of the electrode pack 110 (e.g., jellyroll, stack), as shown in FIG. 32, and brought into contact with each other and with the anode terminal 2710. The cathode tabs 412 that were grouped together are folded over the bottom of the electrode pack 110, as shown in FIG. 33, and brought into contact with each other and with the bottom of the can 160 to form the cathode terminal.

Eliminating the anode grating 120 and the cathode grating 130 reduces the size (e.g., height) of electrode pack 110. The tabs of the electrodes, the anode tabs 422 and the cathode tabs 412, that are brought into contact with each other are un-coated (e.g., not insulated, not electrically isolated), so that as they come into physical contact with each other they establish an electrical and physical connection. As with all batteries, the cathode electrodes 410 and the cathode tabs 412 are separated (e.g., insulated) from the anode electrodes 420 and anode tabs 422 by a separator, or other electrically insulative material, or by space (e.g., air). The anode electrodes 420 and the anode tabs 422 are separated and insulated from the can 160 because the can 160 functions as the cathode terminal. The cathode electrodes 410 and the cathode tabs 412 are separated and insulated from the anode terminal 2710 (e.g., lid).

Folding the anode tabs 422 over each other allows the anode tabs 422, and therefore the anode electrodes 420, to be compressed against each other by the anode terminal 2710 to establish the electrical and physical connection of the anode tabs 422 and anode electrodes 420, with each other, and the anode terminal 2710. Folding the cathode tabs 412 over each other allows the cathode tabs 412, and therefore the cathode electrodes 410, to be compressed against each other and against the can 160 to establish the electrical and physical connection of the cathode tabs 412 and the cathode electrodes 410 to each other and to the can 160.

Manufacturing the electrode pack 110 without the anode grating 120 and/or the cathode grating 130 not only decreases the size of the electrode pack 110, but also simplifies manufacturing because the welding used to connect the tabs to the respective gratings is eliminated.

### Method for Assembling an Electrode Pack

An example embodiment of a method for assembling an electrode pack includes assembling a plurality of electrode groups, positioning the plurality of the electrode groups with respect to an anode grating and a cathode grating, folding each anode tab group and folding each cathode tab group.

Each electrode group includes a plurality of anode electrodes and a plurality of cathode electrodes. Each anode electrode and each cathode electrode includes a body and a tab. The tab of each electrode extends from the body of the electrode. The tab electrically connects to the body of the electrode. The tab of each anode electrode is oriented in a first direction to form an anode tab group. The tab of each cathode electrode is oriented in a second direction to form a cathode tab group. The second direction is different from the first direction by at least 90 degrees. For example, in an example embodiment, the tab of each anode electrode is oriented in an upward direction (e.g., 0 degrees) whereas the tab of each cathode electrode is oriented in a downward direction (e.g., 180 degrees). In another example embodiment, the tab of each anode electrode is oriented in an upward direction whereas the tap of each cathode electrode is oriented in a rightward direction (e.g., 90 degrees). The plurality of the anode electrodes are interleaved with the plurality of the cathode electrodes. In other words, an anode electrode is positioned with its tab in the first direction, chemistry is positioned on the anode electrode, then a cathode electrode is positioned with its tab in the second direction over the chemistry as best seen in FIGS. 4 and 5.

As the plurality of anode electrodes and cathode electrodes are assembled to interleave each other, the tab of each anode electrode of a same (e.g., particular, specific) electrode group is brought into contact with one or more other tabs of the anode electrodes of the same electrode group. In particular, each tab of the anode electrodes of the same electrode group are brought into physical and thereby electrical contact with the tabs of adjacent anode electrodes. The contact between the tabs of the anode electrodes brings the tab of all other anode electrodes of the same electrode group into electrical contact with each other.

The same type of contact occurs with the tabs of the cathode electrodes of the same electrode group. So as the plurality of anode electrodes and cathode electrodes are assembled to interleave each other, the tab of each cathode electrode of a same electrode group is brought into contact with one or more other tabs of the cathode electrodes of the same electrode group. In particular, each tab of the cathode electrodes of the same electrode group are brought into physical and thereby electrical contact with the tabs of adjacent cathode electrodes. The contact between the tabs of the cathode electrodes brings the tab of all other cathode electrodes of the same electrode group into electrical contact with each other.

Positioning the plurality of the electrode groups with respect to an anode grating and a cathode grating result in each anode tab group being positioned through one opening respectively of the anode grating and each cathode tab group being positioned through one opening respectively of the cathode grating. Positioning the plurality of electrode groups includes inserting each anode tab group of each electrode group through one opening respectively in the anode grating thereby positioning the body of each anode electrode on a first side of the anode grating and a portion of the tab of each anode electrode on a second side of the anode grating as best seen in FIG. 16.

Positioning the plurality of electrode groups further includes inserting each cathode tab group of each electrode group through one opening respectively in the cathode grating thereby positioning the body of each cathode electrode on a first side of the cathode grating and a portion of the tab of each cathode electrode on a second side of the cathode grating. Although the cathode tab groups are not shown inserted into the openings of the cathode grating in the figures, FIG. 16 is representative of how the cathode tab groups would stick through the openings of the cathode grating to be positioned on the second side of the cathode grating.

Folding each anode tab group includes folding each anode tab group over to bring one or more tabs of each anode tab group into physical and electrical contact with the anode grating. As discussed above, each anode tab group is inserted through a respective opening in the anode grating. Folding each anode tab group includes bending each anode tab group over an edge of the opening through which the anode tab group is inserted and pressing on each anode tab group until the portion of at least one tab of one anode electrode physically contacts the second side of the anode grating as best shown in FIG. 17.

Folding each anode tab group includes applying a force to each anode tab group so that each anode tab group remains bent and in physical contact with the second side of the anode grating after the force is removed. Generally, the electrodes (e.g., anode, cathode) are formed of a metal, so the tabs will bend and stay bent and in contact with the grating.

Folding each cathode tab group includes folding each cathode tab group over to bring one or more tabs of each cathode tab group into physical and electrical contact with the cathode grating. As discussed above, each cathode tab group is inserted through a respective opening in the cathode grating. Folding each cathode tab group includes bending each cathode tab group over an edge of the opening through which the cathode tab group is inserted and pressing on each cathode tab group until the portion of at least one tab of one anode electrode physically contacts the second side of the cathode grating.

Folding each cathode tab group includes applying a force to each cathode tab group so that each cathode tab group remains bent and in physical contact with the second side of the cathode grating after the force is removed. Generally, as discussed above, the electrodes (e.g., anode, cathode) are formed of a metal, so the tabs will bend and stay bent and in contact with the grating.

### Method for Assembling a Battery Cell

An example embodiment of a method for assembling a battery pack includes placing a gasket, placing a sock, inserting an electrode pack, placing a lid and connecting the lid. In particular, placing the gasket includes placing a gasket over a lip of an opening of a can, the lip encircles the opening of the can. placing the sock includes placing the sock over the gasket whereby the gasket electrically separates the sock from the can. Inserting the electrode pack includes inserting the electrode pack into the can via the opening. The electrode pack includes a plurality of electrode groups, a cathode grating in an anode grating. Each electrode group includes a plurality of cathode tab groups and anode tab groups. Placing the lid includes placing a lid over the opening. Connecting the lid includes connecting the lid to the sock.

After placing the gasket, placing the sock, inserting the electrode pack, placing the lid and connecting the lid are performed, the lid presses on the electrode pack thereby bringing at least one of the cathode tab groups and/or the cathode grating into physical and electrical contact with the bottom or the side of the can. Because at least one of the cathode tab groups and/or the cathode grating is in electrical contact with the can, the can functions as the cathode terminal of the battery cell. The can functions as the cathode terminal because a current may flow into or out of the cathode electrodes via the can.

After placing the gasket, placing the sock, inserting the electrode pack, placing the lid and connecting the lid are performed, the lid physically and electrically contacts at least one of the anode tab groups and/or the anode grating. Because at least one of the anode tab groups and/or the anode grating is in electrical contact with the lid, the lid functions as the anode terminal of the battery cell. The lid functions as the anode terminal because a current may flow into or out of the anode electrodes via the lid. Because the lid is connected to the sock and the sock is electrically separate from the can, the sock may also function as the anode terminal for the battery cell.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A battery cell comprising:
a plurality of anode electrodes, each anode electrode having a body and a tab;
a plurality of cathode electrodes, each cathode electrode having a body and a tab;
an anode grating and a cathode grating, each grating having a first side, a second side, a plurality of bars and a plurality of openings, one opening positioned between each bar; wherein:
the body of each anode electrode is positioned on the first side of the anode grating;
the tab of each anode electrode is positioned through one opening of the anode grating, a portion of the tab of each anode electrode is positioned on the second side of the anode grating;
the body of each cathode electrode is positioned on the first side of the cathode grating; and
the tab of each cathode electrode is positioned through one opening of the cathode grating, a portion of the tab of each cathode electrode is positioned on the second side of the cathode grating.

2. The battery cell of claim 1 wherein at least one of the anode grating and the cathode grating is formed of a single piece of material.

3. The battery cell of claim 1 wherein the bars of the plurality of bars of at least one of the anode grating and the cathode grating are parallel to each other.

4. The battery cell of claim 1 wherein a number of the tabs of the anode electrodes positioned in each opening of the anode grating is equal.

5. The battery cell of claim 1 wherein a number of the tabs of the cathode electrodes positioned in each opening of the cathode grating is equal.

6. The battery cell of claim 1 wherein:
the tabs of the anode electrodes are folded to bring the tabs of the anode electrodes into contact with the anode grating thereby electrically coupling the plurality of anode electrodes to the anode grating and to each other; and
the anode electrodes electrically couple in parallel to each other.

7. The battery cell of claim 1 wherein:
the tabs of the cathode electrodes are folded to bring the tabs of the cathode electrodes into contact with the cathode grating thereby electrically coupling the plurality of cathode electrodes to the cathode grating and to each other; and
the cathode electrodes electrically couple in parallel to each other.

8. The battery cell of claim 1 further comprising a can and a lid, wherein:
the can has an opening;
the lid adapted to cover the opening;
the lid adapted to mechanically but not electrically connected to the can;
the plurality of anode electrodes, the plurality of cathode electrodes, the anode grating and the cathode grating are positioned in the can;
at least one of the portion of the tab of each cathode electrode and the cathode grating contacts the can whereby the can functions as a cathode terminal of the battery cell; and
at least one of the portion of the tab of each anode electrode and the anode grating contacts the lid whereby the lid functions as an anode terminal of the battery cell.

9. The battery cell of claim 8 further comprising a gasket and a sock, wherein:
the can includes a lip around the opening;
the gasket is positioned around the opening of the can over the lip;
the sock is positioned around the can and over the gasket, the gasket electrically separates the sock from the can;
the lid mechanically and electrically coupled to the sock; and
the sock retains the lid mechanically coupled to the can.

10. A battery cell comprising:
a plurality of anode electrodes, each anode electrode having a body and a tab;
a plurality of cathode electrodes, each cathode electrode having a body and a tab;
an anode grating and a cathode grating, each grating having a first side, a second side, a plurality of bars and a plurality of openings, one opening positioned between each bar; wherein:
the body of each anode electrode is positioned on the first side of the anode grating;
the tab of each anode electrode is positioned through one opening of the anode grating, a portion of the tab of each anode electrode is positioned on the second side of the anode grating;
the body of each cathode electrode is positioned on the first side of the cathode grating; and
the tab of each cathode electrode is positioned through one opening of the cathode grating, a portion of the tab of each cathode electrode is positioned on the second side of the cathode grating;
the tabs of the anode electrodes are folded to bring the tabs of the anode electrodes into contact with the anode grating thereby electrically coupling the plurality of anode electrodes to the anode grating and to each other; and
the tabs of the cathode electrodes are folded to bring the tabs of the cathode electrodes into contact with the cathode grating thereby electrically coupling the plurality of cathode electrodes to the cathode grating and to each other.

11. The battery cell of claim 10 further comprising a can and a lid, wherein:
the can has an opening;
the lid adapted to cover the opening;
the lid adapted to mechanically but not electrically connected to the can;
the plurality of anode electrodes, the plurality of cathode electrodes, the anode grating and the cathode grating are positioned in the can;
at least one of the portion of the tab of each cathode electrode and the cathode grating contacts the can whereby the can functions as a cathode terminal of the battery cell; and
at least one of the portion of the tab of each anode electrode and the anode grating contacts the lid whereby the lid functions as an anode terminal of the battery cell.

12. The battery cell of claim 11 wherein:
the second side of the anode grating is positioned proximate to the lid; and
the second side of the cathode grating is positioned proximate to a bottom of the can.

13. The battery cell of claim 11 further comprising a gasket and a sock, wherein:
the can includes a lip around the opening;
the gasket is positioned around the opening of the can over the lip;
the sock is positioned around the can and over the gasket, the gasket electrically separates the sock from the can;
the lid mechanically and electrically coupled to the sock; and
the sock retains the lid mechanically coupled to the can.

14. A battery cell comprising:
a can having an opening;
a lid adapted to cover the opening;
a plurality of anode electrodes, each anode electrode having a body and a tab, the tab of each anode electrode oriented in a first direction;
a plurality of cathode electrodes, each cathode electrode having a body and a tab, the tab of each cathode electrode oriented in a second direction, the second direction different from the first direction by at least 90 degrees; wherein:
the plurality of anode electrodes and the plurality of cathode electrodes are positioned in the can;
the lid mechanically but not electrically couples to the can;
the lid retains the plurality of anode electrodes and the plurality of cathode electrodes in the can;
a portion of the tab of each cathode electrode contacts the can whereby the can functions as a cathode terminal of the battery cell; and
a portion of the tab of each anode electrode contacts the lid whereby the lid functions as an anode terminal of the battery cell.

15. The battery cell of claim 14 further comprising an anode grating having a first side, a second side, a plurality of bars and a plurality of openings, one opening positioned between each bar, wherein:
the body of each anode electrode is positioned on the first side of the anode grating;
the tab of each anode electrode is positioned through one opening of the anode grating, the portion of the tab of each anode electrode is positioned on the second side of the anode grating;
the anode grating is positioned inside the can; and
at least one of the portion of the tab of each anode electrode and the anode grating contacts the lid whereby the lid functions as an anode terminal of the battery cell.

16. The battery cell of claim 15 wherein:
the tabs of the anode electrodes are folded to bring the tabs of the anode electrodes into contact with the anode grating thereby electrically coupling the plurality of anode electrodes to the anode grating and to each other; and
the anode electrodes electrically couple in parallel to each other.

17. The battery cell of claim 15 wherein the second side of the anode grating is positioned proximate to the lid.

18. The battery cell of claim 14 further comprising a cathode grating having a first side, a second side, a plurality of bars and a plurality of openings, one opening positioned between each bar, wherein:
the body of each cathode electrode is positioned on the first side of the cathode grating;
the tab of each cathode electrode is positioned through one opening of the cathode grating, the portion of the tab of each cathode electrode is positioned on the second side of the cathode grating;
the cathode grating is positioned inside the can; and
at least one of the portion of the tab of each cathode electrode and the cathode grating contacts the can whereby the can functions as a cathode terminal of the battery cell.

19. The battery cell of claim 18 wherein:
the tabs of the cathode electrodes are folded to bring the tabs of the cathode electrodes into contact with the cathode grating thereby electrically coupling the plurality of cathode electrodes to the cathode grating and to each other; and
the cathode electrodes electrically couple in parallel to each other.

20. The battery cell of claim 18 wherein the second side of the cathode grating is positioned proximate to a bottom of the can.
